(19) United States
(12) Patent Application Publication
(10) Pub. No.: US 2004/0257622 A1
(43) Pub. Date: Dec. 23, 2004

(54) Image processing apparatus, image processing system, and computer program

(76) Inventors: Hiroyuki Shibaki, Tokyo (JP); Noriko Miyagi, Kanagawa (JP); Hirosi Ishii, Kanagawa (JP); Kazunari Tonami, Kanagawa (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/825,797

(22) Filed: Apr. 9, 2004

(30) Foreign Application Priority Data
Apr. 16, 2003 (JP) 2003-111602

(51) Int. Cl. H04N 1/40; H04N 1/405; H04N 1/56

(52) U.S. Cl. 358/2.1; 358/3.28; 715/911; 358/3.06

(57) ABSTRACT

An image processing apparatus includes an image attribute determining unit that determines an image attribute of an image data, an object dissolving unit that dissolves the image data into a plurality of objects based on the image attribute, and an object describing unit that describes the objects in predetermined formats and converts the objects into a file of a predetermined file format. The object describing unit describes an object having a predetermined image attribute among the objects by associating an additional object representing information on the predetermined image attribute with the object.

The present application claims priority to the corresponding Japanese Application No. 2003-111602, filed on Apr. 16, 2003, the entire contents of which are hereby incorporated by reference.

### BACKGROUND OF THE INVENTION

1. Field of the Invention

One embodiment of the present invention relates to a technology for converting a paper document into an electronic file and enhancing image quality when printing the electronic file.

2. Description of the Related Art

It is becoming popular to convert a paper document into an electronic form using a scanner function of a digital copying machine or a single scanner to facilitate storing and distributing various documents.

Since the document converted into an electronic file is a single plane image, when it is printed out, the entire area in the image including a text area and a picture area is subjected to a uniform halftone processing. As the halftone processing, dithering is generally used based on a threshold value using a dither matrix. Dithering with a relatively small number of lines is used for satisfying tone and graininess in a picture area such as a photograph. For example, a general color printer uses about 133 to 200 lines. In a text area, it is preferable to perform a halftone processing with excellent sharpness using dithering with more lines or error diffusion processing. Under present circumstances, however, few color printers can satisfy image quality for both the text area and picture area.

A technology to convert an image into an electronic file with high compression and high image quality is disclosed in, for example, Japanese Patent Application Laid-Open No. 2002-77633. The technology divides a scanned image into a text area and a picture area, and employs an optimal compression method for each object by creating a modified read (MMR) compressed image having color information and a Joint photographic experts group (JPEG) compressed image for the text area and the picture, respectively. One of the image expression methods using such a large number of objects is the well-known portable document format (PDF).

The PDF is a page description language used for describing on the object basis proposed by Adobe Systems, and the resulting file is in an object description format. A browser for the PDF document is also distributed free, and the PDF is now occupying a high share of the market. Since the PDF document is described on the object basis, the PDF document can be regarded as a format having an image attribute.

In Patent Application Laid-Open No. 2002-77633, the MMR compressed object is a text object, and the JPEG compressed object is a picture object that is an object other than the text object. If a printer driver can identify the image attribute of these objects when printing the object, dithering with excellent sharpness is applied to the text object, and dithering with excellent tone and graininess is applied to the picture object, making it possible to achieve excellent image quality for both the text object and the picture object.

According to the printing procedure of Windows® system, image attribute information is not transmitted to a printer driver. In the Windows® system, if a user instructs an application software to start a printing processing, the application calls a drawing command called graphics device interface (GDI) that is graphics drawing application programming interface (API) constituting a portion of Windows® kernel. The GDI command is converted into a device driver interface (DDI) command and transferred to the printer driver, and the printer driver converts the DDI command into a print instruction for a printer and transfers the print instruction to the printer.

The printer interprets the print instruction and executes the printing. If the application has a mechanism to call different GDI commands for the MMR object and the JPEG object, the printer driver can distinguish the text area from the picture area. In practice, however, since the same GDI command is used for both areas as an image object, it is impossible to distinguish the text area from the picture area.

### SUMMARY OF THE INVENTION

An image processing apparatus, image processing system, and computer program are described. In one embodiment, the image processing apparatus comprises an image attribute determining unit to determine an image attribute of an image data, an object dividing unit to divide the image data into a plurality of objects based on the image attribute, and an object describing unit to describe the objects in predetermined formats and convert the objects into a file of a predetermined file format, wherein the object describing unit describes an object having a predetermined image attribute among the objects by associating an additional object representing information on the predetermined image attribute with the object.

### BRIEF DESCRIPTION OF THE DRAWINGS

FIG. 1 is a block diagram of an image processing system according to one embodiment of the present invention;

FIG. 2 is a block diagram of a format converter of the image processing system shown in FIG. 1;

FIG. 3 is a schematic of an example of image data read from a document using a color scanner;

FIG. 4 is a schematic for illustrating a text area of the image data shown in FIG. 3;

FIG. 5 is a schematic for illustrating a text object of the image data shown in FIG. 3;

FIG. 6 is a schematic for illustrating an active pixel of the text object of the image data shown in FIG. 3;

FIG. 7 is a schematic for illustrating a picture object (object 1) of the image data shown in FIG. 3;

FIG. 8 is a schematic for illustrating three text objects (objects 2 to 4) of the image data shown in FIG. 3;

FIG. 9 is a schematic for illustrating additional objects (objects 5 to 7);

FIG. 10 is a schematic for illustrating additional objects (objects 8 to 10);

FIG. 11 is a schematic of an example of the object of the image data shown in FIG. 3;

FIG. 12 is a block diagram of a data converting unit of the image processing system shown in FIG. 1;

FIG. 13 is a schematic of an example of an identification pattern representing a text attribute;

FIG. 14 is a schematic of another example of the identification pattern representing the text attribute;

FIG. 15 is a schematic of an example of a description of an object according to one embodiment of the present invention; and

FIG. 16 is a table of image attributes and an object description method, a compressing method, and an image processing method for each of the image attributes according to one embodiment of the present invention.

### DETAILED DESCRIPTION

Embodiments of the present invention solve at least the problems in the conventional technology.

The image processing apparatus according to one embodiment of the present invention includes an image attribute determining unit that determines an image attribute of an image data, an object dividing unit that divides the image data into a plurality of objects based on the image attribute, and an object describing unit that describes the objects in predetermined formats and converts the objects into a file of a predetermined file format. The object describing unit describes an object having a predetermined image attribute among the objects by associating an additional object representing information on the predetermined image attribute with the object.

The image processing system according to another embodiment of the present invention includes an image processing apparatus including an image attribute determining unit that determines an image attribute of an image data, an object dividing unit that divides the image data into a plurality of objects based on the image attribute, and an object describing unit that describes the objects in predetermined formats and converts the objects into a file of a predetermined file format, and a printer that receives the print instruction and prints the document. The object describing unit describes an object having a predetermined image attribute among the objects by associating an additional object representing information on the predetermined image attribute with the object.

A computer program as part of another embodiment of the present invention causes a computer to execute a method that includes determining an image attribute of an image data, dividing the image data into a plurality of objects based on the image attribute, describing the objects in predetermined formats, and converting the objects into a file of a predetermined file format. The describing includes describing an object having a predetermined image attribute among the objects by associating an additional object representing information on the predetermined image attribute with the object.

The other objects, features, and advantages of embodiments of the present invention are specifically set forth in or will become apparent from the following detailed description of the invention when read in conjunction with the accompanying drawings.

Exemplary embodiments of an image processing apparatus, an image processing system, and a computer program according to one embodiment of the present invention are explained in detail with reference to the accompanying drawings.

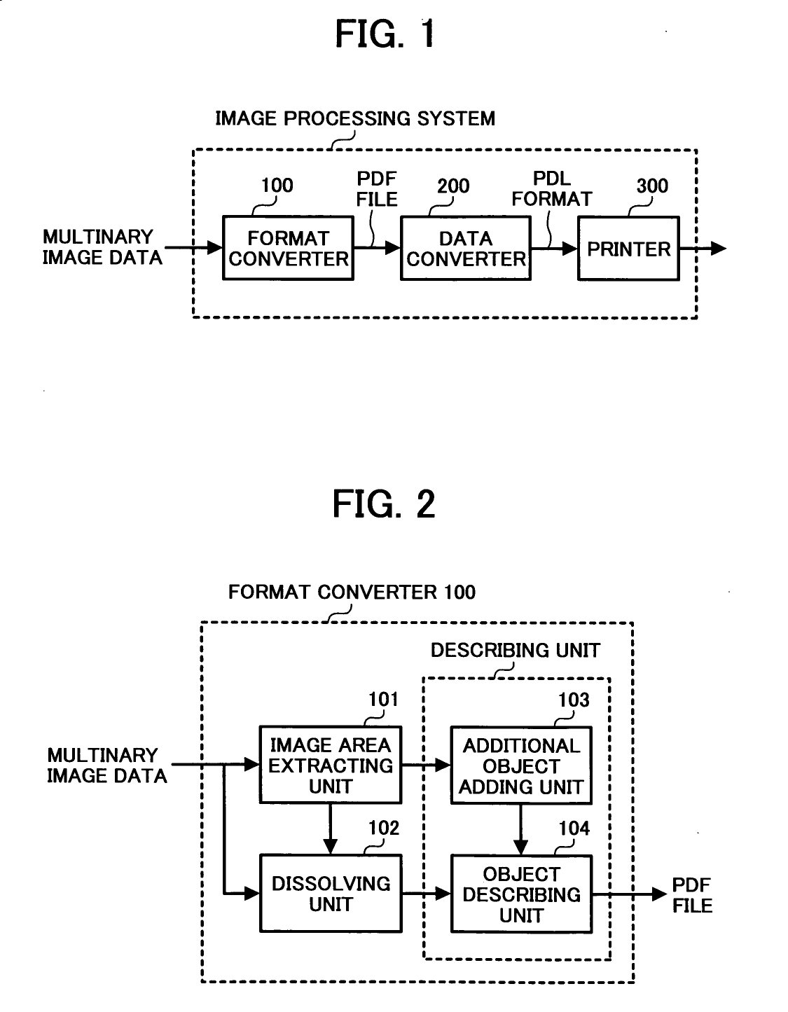

FIG. 1 is a block diagram of an image processing system according to one embodiment of the present invention. The image processing system includes a format converter 100 that divides the multilevel image data read by an image inputting unit (not shown) such as a scanner, into objects and converts the format of the objects into a predetermined file format (e.g., PDF file). The image processing system also includes a data converting unit 200 that converts the file converted by the format converter 100 into print instruction (PDL format) that a printer 300 can interpret, and that allows the printer 300 to output the print instruction. The image processing system also includes the printer 300 that interprets the print instruction input from the data converting unit 200 and carries out the printout. In the above configuration, the format converter 100 and the data converting unit 200 configure an image processing apparatus.

After the multilevel image data read by the image inputting unit such as the scanner is input, and a particular image area of the multilevel image data is extracted, the format converter 100 divides each extracted area into separates objects, and converts the same into PDF file format that is a file format described for each object, and outputs the same to the data converting unit 200.

FIG. 2 is a block diagram of a format converter 100 of the image processing system. The format converter 100 includes an image area extracting unit 101, a dividing unit 102, an additional object adding unit 103, and an object describing unit 104.

The image area extracting unit 101 extracts a text area having a text attribute from the input multilevel image data, and sends coordinate information of the text area and information representing its shape to the dividing unit 102 and the additional object adding unit 103 as extracted text area information.

The dividing unit 102 divides the input multilevel image data into a text object and a picture object based on the extracted text area information input from the image area extracting unit 101, and sends information concerning the text object and the picture object to the object describing unit 104.

The additional object adding unit 103 prepares an additional object indicating that the object includes the text attribute in connection with an object having the text attribute based on the extracted text area information input from the image area extracting unit 101. Then, the additional object adding unit 103 sends the additional object to the object describing unit 104.

The object describing unit 104 describes the text object and the picture object input from the dissolving unit 102 and the additional object that is input from the additional object adding unit 103 and that indicates the text attribute, respectively into PDF files of in a format conforming to PDF.

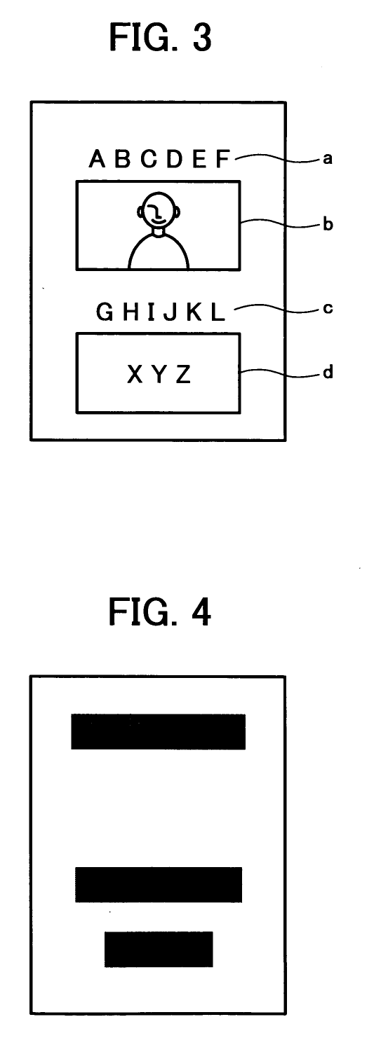

FIG. 3 is a schematic of an example of image data read from a document using a color scanner: (a) represents black text on a white background; (b) represents a picture image; (c) represents red text on the white background; and (d) represents blue text on a uniform background image, i.e., on a color background.

The image area extracting unit 101 extracts, from the image data, a rectangular area, as text area, including pixels that form the text, and outputs the coordinate information of the text area and information representing its shape to the dissolving unit 102 and the additional object adding unit 103. FIG. 4 is a schematic for illustrating a text area of the image data shown in FIG. 3. Three rectangular areas solidly filled with black are the text areas.

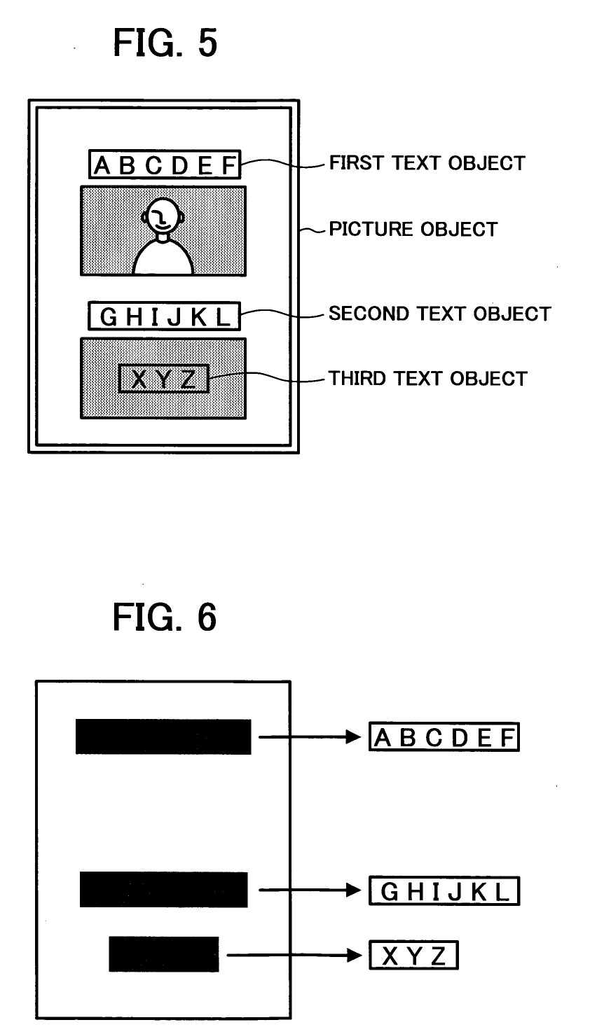

The dividing unit 102 divides the image data into three text areas and other background areas. The area (b), the area other than the text area (d), and the white background area are regarded as one background area, and regarded as a single picture object. That is, as shown in FIG. 5, the dividing unit 102 divides the image data into four objects, i.e., first to third text objects and a picture object.

The dividing unit 102 subjects the extracted rectangular text area to binary processing using an appropriate threshold value, classifies the pixels constituting the text into black pixels (active pixels) and classifies pixels constituting other than text into white pixels (inactive pixels) as shown in FIG. 6, and the active pixels are defined as data indicating the shape of the text. An average color of the active pixels is obtained as a representative color of the text.

Concerning the text object, the dividing unit 102 sends, to the object describing unit 104, top coordinate information of the text area (rectangular area), size information (X size, Y size) of the object, binary shape information, and average color information of the active pixels.

The top coordinate information of the text object indicates coordinates of the text object in all image areas, and is a coordinate value of an origin (left lower point of the text object) in the text object with respect to an image area origin (left lower point of all image area). Such information is sent to all the text objects.

The dividing unit 102 also sends information concerning the picture object to the object describing unit 104. The picture object is in the image area obtained by eliminating the text object from all image areas. The image of the picture object corresponds to an image from which the text area is cut out. As described in Japanese Patent Application Laid-Open No. 2002-77633, if the cut out text area is solidly filled with peripheral pixel values, the compressibility is preferably enhanced when the compressing processing is carried out later. The dividing unit 102 sends, to the object describing unit 104, top coordinate information of the rectangular area with respect to the picture object, size information (X size, Y size) of the object, and image information of RGB 24 bit per one pixel.

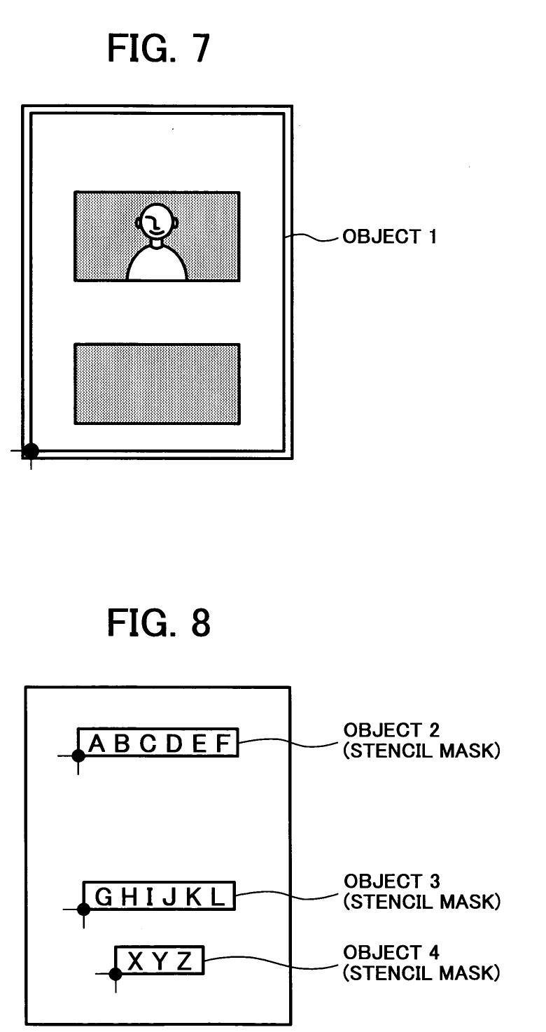

The image data shown in FIG. 3 is divided into a picture object (object 1) shown in FIG. 7 and three text objects (objects 2 to 4) shown in FIG. 8. Left lower marks in each of the objects indicate origin coordinates of the object. In the PDF, a position of an object is determined by designating where the object origin should be disposed in the entire image area under a condition that a left lower portion in the rectangular area is defined as an object origin.

The text object is expressed by painting a text shape expressed as a bitmap using a function of a stencil mask of PDF. As shown in FIG. 8, the bitmap data expressing the text shape created by the dividing unit 102 is used as a mask data of the stencil mask. The white pixels (inactive pixels) in the drawings are areas to be masked, and previous contents are held in the area to be masked. That is, the area to be mask is an area where the background image is displayed as it is.

The black pixels (active pixels) are areas marked with designated color, and colored text is displayed. In order to describe using such a stencil mask, the data is divided into the bitmap data as shown in FIG. 8.

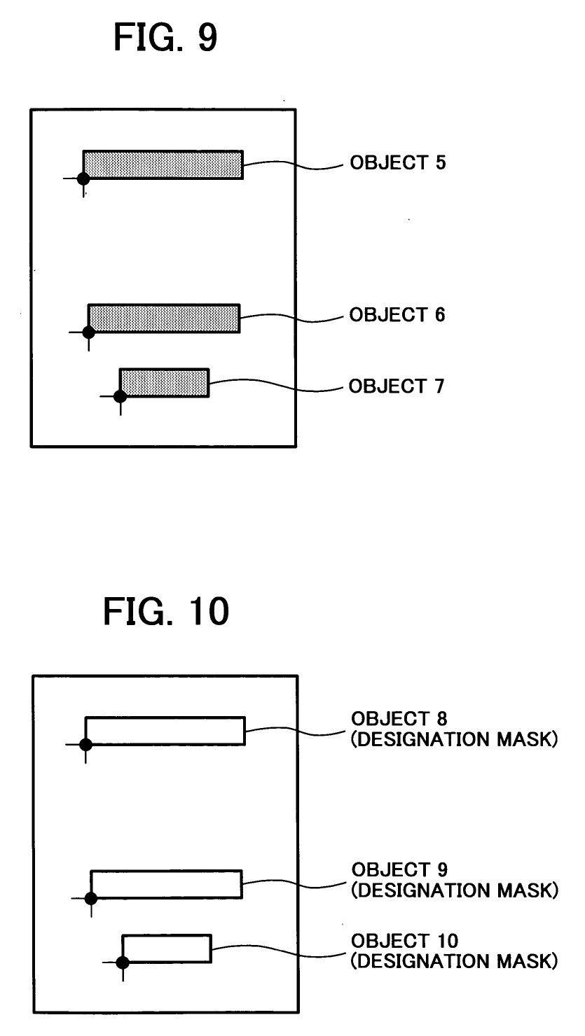

The image data shown in FIG. 3 is divided into the objects 1 to 4 in this manner. According to the invention, since the text object indicates that it has the text attribute, the additional object adding unit 103 newly prepares an additional object as shown in FIG. 9 and FIG. 10.

An object 5 in FIG. 9 corresponds to an object 2 in FIG. 8. The object 5 has the same coordinates and the same size as the object 2, and the object 5 is formed as an image in which all pixels have specific values (e.g., R=0, G=1, B=0). The specific values (R=0, G=1, B=0) are defined as codes to indicate the text attribute, and the printer driver can identify the text attribute. For the objects 3 and 4 in FIG. 8 also, objects 6 and 7 to indicate the text attribute are newly prepared, and they are sent to the object describing unit 104.

In order to make the objects 5 to 7 representing text attribute such that they are not visualized when they are displayed or printed out, the additional object adding unit 103 links the objects 5 to 7 with designation masks 8 to 10 as shown in FIG. 10, and sends them to the object describing unit 104. With this designation mask, the background image is effective in all areas in each object; thus, the objects 5 to 7 are invisible.

The object describing unit 104 describes the object and combines it into a PDF file. The object describing unit 104 first describes a picture object representing a background image, and then describes concerning the text object. Concerning the text object, three objects (an object representing text attribute, an object that brings the text attribute into invisible state, and a text object) are described as one set. First, the object representing the text attribute is described and then, the object (designation mask) for bringing this text attribute into invisible state is described. Lastly, the text object (stencil mask) related to the attribute description is described.

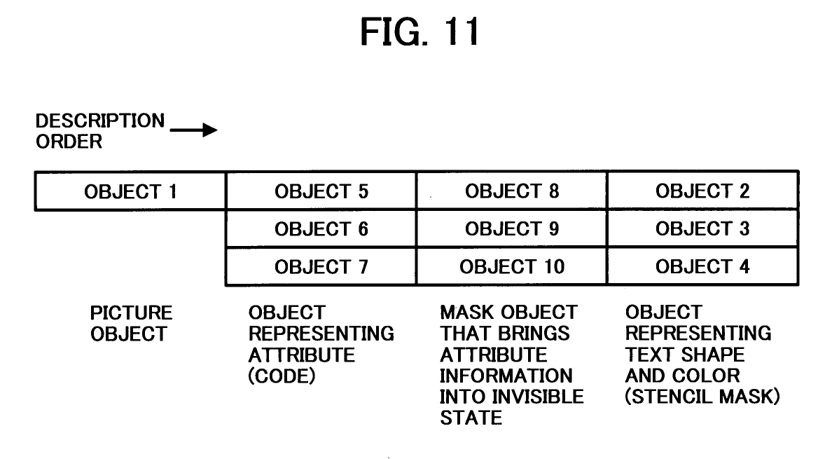

FIG. 11 is a schematic of an example of the object of the image data shown in FIG. 3. A group of the objects 5, 8, and 2, a group of objects 6, 9, and 3, and a group of objects 7, 10, and 4 can be interchanged. According to an object description rule of one embodiment of this invention, an object described immediately after an object representing the text attribute is a text object. Thus, this description order should be followed. The PDF file is created in this manner.

Using the method disclosed in Japanese Patent Application Laid-Open No. 2002-77633, for example, a text object may be subjected to processing such as MMR compression, and for a picture object, a text area may be cut out from an original image and may be solidly filled with peripheral color, and it may be reduced in size or JPEG compressed if necessary. With this, the file size when the object is formed into the PDF file can be reduced.

It is important to set the size of the object representing the attribute (code) to the same as that of the text object. This is because that when a drawing command is transferred from the application to the printer driver, it is unknown in what unit the image is divided and drawn. If the size is the same, the minimum necessary information of object representing attribute+mask object that brings attribute into invisible state+object representing color+mask object representing shape can be transferred as one set irrespective of how the image is cut out and transferred to the printer driver. Thus, predetermined performance can be maintained.

The electronified PDF document file is accumulated or distributed by e-mail or the like, and finally opened on a user's personal computer (PC) by application software such as the Acrobat Reader or the like. In the Windows® system, the application software calls a GDI command to display the contents of the PDF file on a display and sends draw-instructions to the Windows® system. In the Windows® system, an image is displayed on the display based on the draw-instructions. The attribute information with respect to the text object described in the above method is an invisible object and thus, it is not displayed and no problem occurs.

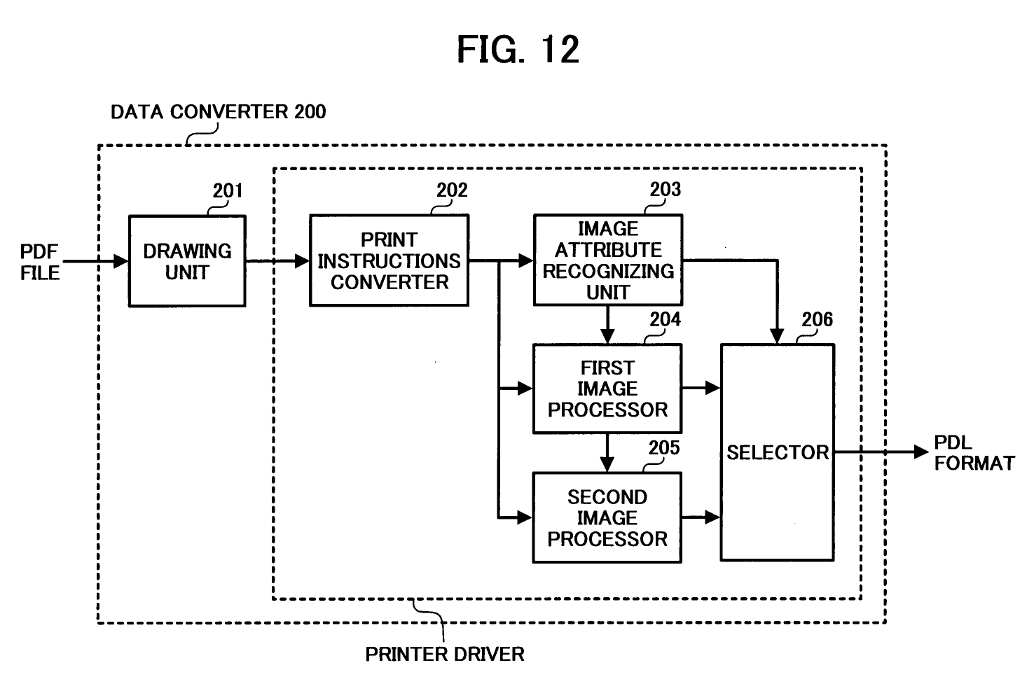

FIG. 12 is a block diagram of a data converting unit 200 of the image processing system. The data converting unit 200 includes a drawing unit 201, a print instruction converter 202, an image attribute recognizing unit 203, a first image processor 204, a second image processor 205, and a selector 206. The drawing unit 201 converts the PDF file into DDI command and outputs draw-instructions. The print instruction converter 202 converts draw-instructions input from the drawing unit 201 into print instruction (PDL form) for the printer 300 and outputs the print instruction to the image attribute recognizing unit 203, the first image processor 204, and the second image processor 205. The image attribute recognizing unit 203 recognizes an attribute of an object from the input print instruction, and switches over the output of the selector 206 in accordance with the attribute of the object. The first image processor 204 subjects the input print instruction to image processing suitable for text, and outputs the same to the selector 206. The second image processor 205 subjects the input print instruction to image processing suitable for picture, and outputs the same to the selector 206. The selector 206 switches over the output of the first image processor 204 and the output of the second image processor 205 in accordance with instructions of the image attribute recognizing unit 203, and outputs the same to the printer 300.

The drawing unit 210 includes the Windows® system, the application software, the GDI command producing unit, the DDI command producing unit, and the like. Like the displaying manner on the display, the application software calls the GDI command at the time of printout. The Windows® system performs conversion to DDI command suitable for a printer device based on the GDI command, and outputs the draw-instructions to the print instruction converter 202. At that time, the text object and the picture object described by the above method and the attribute information of the text object are output from the drawing unit 201 as draw-instructions.

The print instruction converter 202, the image attribute recognizing unit 203, the first image processor 204, the second image processor 205, and the selector 206 are called printer drivers that are supplied by a printer maker and are driver software inherent in that printer.

The image attribute recognizing unit 203 inputs the print instruction, recognizes attribute information of the object, outputs switch-instructions to the selector 206, and switches between the output of the first image processor 204 and the output of the second image processor 205. More specifically, the image attribute recognizing unit 203 recognizes an object drawn immediately after an object having a particular attribute (code) as a text object in accordance with the object description rule, and recognizes other objects as picture objects. When the object is a text object, the image attribute recognizing unit 203 allows the selector 206 to output a processing result of the first image processor 204, and when the object is a picture object, the unit 203 allows the selector 206 to output a processing result of the second image processor 205. With this configuration, a processing result obtained by performing image processing suitable for text is output to the printer 300 when the object is the text object, and a processing result obtained by performing image processing suitable for picture is output to the printer 300 when the object is the picture object.

In one embodiment, an object is determined as being representing attribute when the following conditions are satisfied:

1) data is written in specific color;

2) object representing attribute is image solidly filled (solidly shaded image);

3) object (designation mask) that brings attribute information into invisible state is solidly filled (solidly shaded image) and transparent; and

4) object to be described next has the same size as object representing attribute.

The first image processor 204 performs image processing such as color correction, black generation, and halftone processing suitable for text in response to the input print instruction and outputs the same to the selector 206. More specifically, the first image processor 204 corrects color and generates black color such that when text has almost achromatic color, the black generation ratio is relatively increased or remaining color component after the black color is generated is removed so that the achromatic color text can be seen sharply without color, and in the halftone processing, dither processing having large number of lines is carried out to enhance the sharpness of the text.

The second image processor 205 carries out image processing such as color correction, black generation, and halftone processing suitable for picture in response to the input print instruction and outputs the same to the selector 206. More specifically, in the color correcting and black generation processing, the second image processor 205 sets the black generation ratio lower than that of the first image processor 204 so that wider tone can be obtained, and in the halftone processing, the second image processor 205 performs dither processing having relatively small number of lines, thereby enhancing the graininess and tone of the picture.

The selector 206 outputs, to the printer 300, a processing result of the first image processor 204 when the object is a text object and outputs, to the printer 300, a processing result of the second image processor 205 when the object is a picture object in accordance with switch-instructions of the image attribute recognizing unit 203. With this, high image quality can be achieved for both the text area and the picture area.

For example, even when the processing result is output to a printer that can not recognize the transmission rule of attribute of the object, since the attribute information with respect to the text object is described with invisible object, an unintentional pattern or image does not appear on output of the printer, and there is caused no problem.

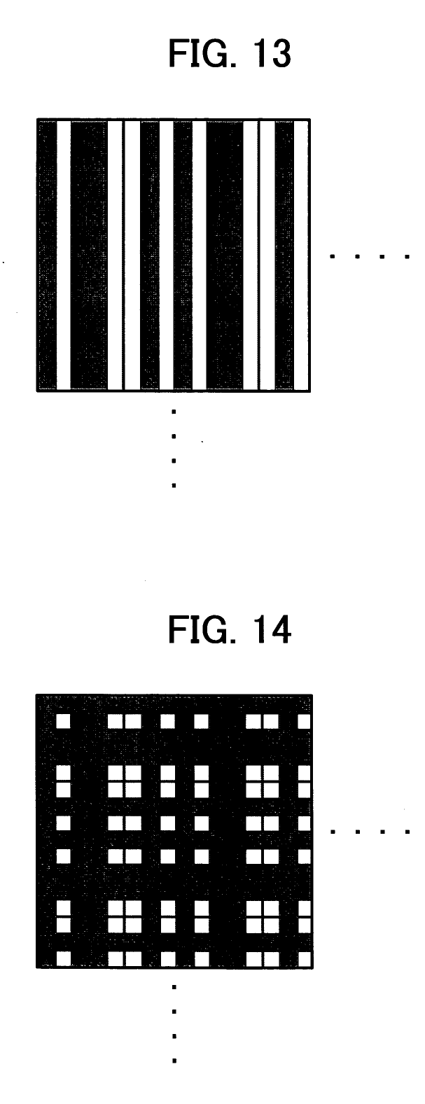

According to one embodiment, the specific color value (R=0, G=1, B=0) is used as the identification pattern (code) representing text attribute, but the invention is not limited to this. For example, specific black and white binary patterns in a barcode as shown in FIG. 13 may be used. In the example shown in FIG. 13, the specific pattern of black and white is periodically repeated every 8 pixels. Alternatively, black and white binary patterns may be disposed two-dimensionally so that it is possible to deal with when a drawing command is produced after it is rotated through 90 degrees.

According to one embodiment, an object next to an object having a specific color value has a text attribute. There is an adverse possibility that a produced object coincidentally has the equivalent color value, is linked with a mask object and thus, is erroneously determined as a text object. To prevent such an erroneous determination, sets of objects (code object+mask object for establishing invisible state) may be attached to the same position to reduce the coincidental conformity, thereby reducing the erroneous determination.

When data is output by a printer that can interpret the description rule of objects of the invention, a user may select whether processing of a text object and processing of a picture object should be switched over by the printer driver, and the processing may be performed in accordance with the selected result. With this configuration, when it is desired to obtain the same image quality as that when the user uses another printer, i.e., when it is desired to obtain the same output as that subjected to uniform picture processing, it is possible not to switch the processing.

According to one embodiment, in the format converter 100, when multilevel image data is divided into a plurality of image objects and each object is described in a predetermined file format, an image attribute of the multilevel image data is identified, and in accordance with a result of the identification, an object having an image attribute is described while linking an additional object representing attribute information to that object. The data converting unit 200 determines an object having a predetermined image attribute based on the added additional object, and contents of the image processing are changed in accordance with the image attribute. Thus, when they are formed into a file, the identified image attribute can be transferred to the printer driver, the printer can output an image subjected to appropriate image processing suitable for the image attribute, and both text image quality and picture image quality obtained when the image is printed out can be satisfied.

Since the additional object is the invisible object in one embodiment, even when data is output on a monitor or to a printer that cannot recognize the object description rule, no problem occurs.

Since the object size of the additional object is the same as that of the text object in one embodiment, the attribute information can reliably be transmitted irrespective of how an image is divided by the application and sent to the printer driver.

According to one embodiment, an object determined as having a text attribute is subjected to a halftone processing having high sharpness as compared with an object determined as having other attributes. Thus, text can be reproduced with high image quality.

According to one embodiment, for an object having an achromatic color text attribute, the amount of black component is increased in the color correcting processing and black generation processing, or remaining color component is removed. Thus, black text can be reproduced with high image quality.

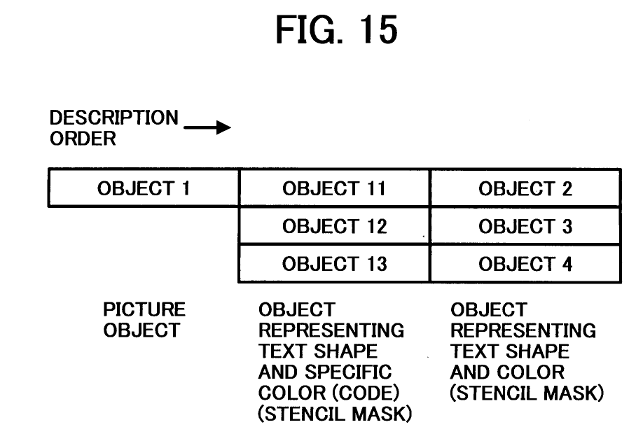

FIG. 15 is a schematic of an example of a description of an object according to one embodiment of the present invention. According to one embodiment, an object having code information linked with a text object is a transparent (invisible) object, attribute information is transmitted to the printer driver, and when the image is displayed on a monitor or a display, or printed out, the image does not appear abnormal. According to one embodiment, a text object is repeatedly described while changing designated color, and attribute information is transmitted to the printer driver. Since the image processing system of one embodiment has a configuration almost the same as that of one embodiment, only different points will be explained.

The operation up to the dividing unit 102 is the same as that described above. For a text image, the dividing unit 102 outputs data representing shape, coordinate information, and representative color information.

The additional object adding unit 103 outputs, to the object describing unit 104, an additional object (object representing attribute) representing text object, like in one embodiment. The object output has bitmap data having the same shape as that of the text object output by the dividing unit 102, coordinate information, and specific color (code) information representing text attribute. This object is described immediately before the text object, like in the embodiments above.

Generally, an object having original text color is overwritten on an added object and this is displayed or printed out by a printer. Therefore, text having unintentional color does not appear on the output image, and no problem occurs.

The printer driver determines that an image drawn on an image area that is solidly filled with specific color has a text attribute, and performs processing suitable for the text image. With this, the text image quality when it is printed out can be enhanced.

Specifically, it is determined that an object has an attribute if data is written in a specific color, and if the object has the same shape as that described next.

According to one embodiment, shape data (binary bitmap data) of an additional object representing text attribute is the same as a text object. Therefore, there is an effect that the shape data can commonly be used, it is unnecessary to hold data as image data, and file size hardly increased.

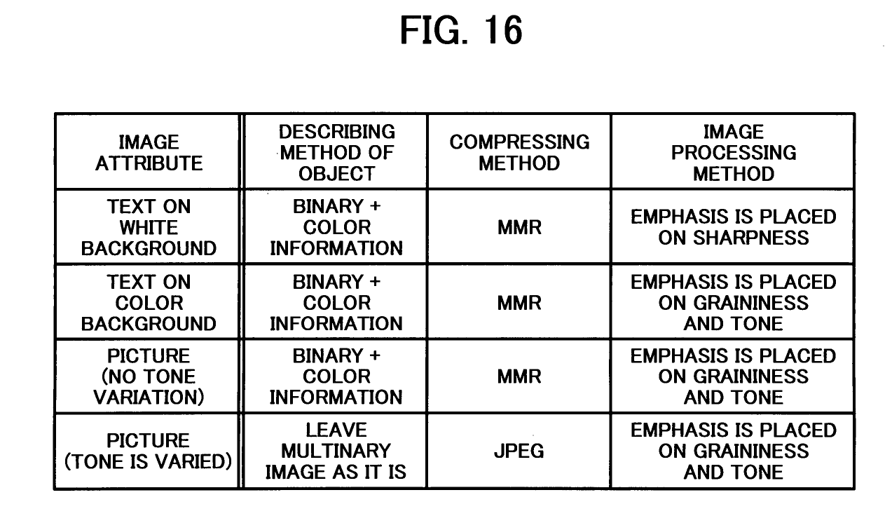

FIG. 16 is a table of image attributes and an object description method, a compressing method, and an image processing method for each of the image attributes according to one embodiment of the present invention. According to a previously described embodiment, an object determined as having a text attribute is subjected to halftone processing having higher sharpness than that of other picture object. According to another embodiment, text on white background among text attributes is subjected to processing having higher sharpness, and the text on the color background and picture area are subjected to processing having excellent graininess and tone suitable for a picture. Since the image processing system of one embodiment has a configuration almost the same as that of a previously described embodiment, only different points will be explained.

The format converter 100 of one embodiment describes an object using the object description method as shown in FIG. 16 in accordance with each image attribute. The data converting unit 200 subjects an object to compressed image processing using the compressing method and the image processing method shown in FIG. 16 in accordance with each image attribute.

It is effective for text on a white background to perform MMR compression as binary+color information to reduce image size. Concerning the image processing method, processing in which emphasis is placed on sharpness is suitable. The processing where emphasis is placed on sharpness is dither processing having excellent sharpness in which the black generation ratio is high and the number of screen lines is high.

For text on a color background, the same processing as that for text on a white background is suitable in terms of image size, but for the image processing method, processing in which emphasis is placed on graininess and tone is desirable. It is necessary to perform processing in which emphasis is placed on graininess and tone for background of text on color background, i.e., picture image on background. This is because if processing of background image and processing of text on color background are different from each other, an incongruity is caused in the boundary portion. If the sharpness of text on color background is taken into account, processing placing emphasis on sharpness should be performed, but since incongruity with respect to the background image is stronger than the impression of a reduction of image quality, processing placing emphasis on graininess and tone is appropriate.

Concerning the picture area, when the background image is uniform and having no tone variation, it is suitable to describe the picture area with binary+color information and to compress the same in MMR manner like text. If there is variation in tone, a multilevel image compressing method such as JPEG is suitable. In the image processing method, it is suitable to select processing that is excellent in graininess and tone.

It is not necessary to pair the object description method and the compressing method with optimal image processing method. If the image attribute is more finely divided, the image quality is enhanced. In order to transmit image attributes to the printer driver, specific patterns and values in an object representing attribute should be prepared.

According to one embodiment, text on a white background can be reproduced with high image quality.

According to one embodiment, there is no defect caused by switching the processing between the text on a color background and a background portion, and image can be reproduced with high image quality.

According to several embodiments, a PDF file is used as a file of object description format, but the invention is not limited to this, and file of other object description format can also be used.

The printer 300 may have the function of the data converting unit 200, and the printer 300 may perform the image processing suitable for image attribute of an object.

The image processing apparatus of the invention may be applied to a system having devices (e.g., a host computer, an interface device, a scanner, a printer), or may be applied to an apparatus having one device (such as a host computer).

Embodiments of the present invention include supplying, to a system or an apparatus, a recording medium having program code of software for realizing function of the image processing apparatus stored therein, and by allowing a computer of the system or the apparatus (or central processing unit (CPU), micro processing unit (MPU), digital signal processor (DSP)) to execute the program code stored in the recording medium. In this case, the program code read out from the recording medium realizes the function of the image processing apparatus, and the recording medium having the program code or the program stored therein constitutes one embodiment of the present invention. As the recording medium for supplying the program code, it is possible to use an optical recording medium, a magnetic recording medium, a magneto-optic recording medium, and a semiconductor recording medium such as a floppy disk (FD), a hard disk (HD), an optical disk, a magneto-optical (MO) disk, a compact disc read only memory (CD-ROM), a CD-Recordable (CD-R), a magnetic tape, a nonvolatile memory, and a ROM.

If the program code is read out by the computer, the function of the image processing apparatus is realized, an operating system (OS) running on the computer carries out a portion or all of the actual processing based on the instructions of the program code, and this processing realize the function of the image processing apparatus.

The program code read out from the recording medium is written into a memory provided in an expansion board inserted into a computer or provided in an expansion unit connected to a computer. Then, based on instructions of the program code, a CPU or the like provided in the expanded board or the expanded unit carries out a portion or all of the actual processing, and this processing realizes the function of the image processing apparatus, obviously.

A target image file may be downloaded from an image server that accumulates scanner images, and a user may convert the file into PDF using a PC. In this case, the file is converted into the PDF file using the method of one embodiment of the invention. In this case, when a user having received the file prints out the file, if that printer can interpret the rule of the invisible object representing the image attribute of this invention, it is possible to obtain high quality printout that satisfies text sharpness and graininess and the tone of a picture. When a printer that cannot interpret this rule is used, the output is similar to one that is uniformly subjected to processing for a picture and has low text quality, but the embedded attribute information object does not adversely affect the output image quality.

The present invention is not limited to the above embodiments, and may be appropriately modified without departing from the spirit of the invention.

According to the image processing apparatus of one embodiment, in the image processing apparatus that divides image data into objects and converts format into predetermined file format, the apparatus includes an image attribute determining unit that determines image attribute of the image data, an object dividing unit that divides the image data into objects based on a determination result of the image attribute determining unit, and an object describing unit that describes the objects divided by the object dissolving unit in predetermined format and converts the format of the same into the predetermined file format. The object describing unit describes such that an object having predetermined image attribute among the divided objects is linked with an additional object representing attribute information. Therefore, various effects can be obtained by this aspect. For example, the image attribute determined when the image data is formed into a file could be transmitted to a printer driver. Accordingly, the printer driver can perform image processing suitable for the image attribute. With this, the image can be printed out while satisfying both text image quality and picture image quality, and a file in the object description format can be printed out from the printer with high image quality.

According to one embodiment, in the image processing apparatus of one embodiment, the apparatus further includes a data converting unit that converts the file converted by the object describing unit into print instruction suitable for the printer and outputs the print instruction from the printer. The data converting unit determines an object having a predetermined image attribute based on the additional object, and subjects this object to image processing suitable for the image attribute.

According to another embodiment, in the image processing apparatus, the additional object is an invisible object. Thus, even when a monitor or a printer that cannot interpret a description rule of the object outputs the object, there is an effect that no problem is caused in display or printer output.

According to another embodiment, in the image processing apparatus, the size of the additional object is the same as that of the object having the predetermined image attribute. Thus, there is an effect that the attribute information can reliably be transmitted irrespective of how the object is divided by an application and sent to the printer driver.

According to one embodiment, in the image processing apparatus, the file format is PDF. Thus, there is an effect that a versatile PDF file can be printed out with high image quality.

According to yet another embodiment, in the image processing apparatus, the data converting unit subjects an object determined as having a text attribute, to halftone processing having higher sharpness as compared with an object determined as having other attribute. Thus, there is an effect that text can be reproduced with high image quality.

According to one embodiment, in the image processing apparatus, the data converting unit subjects an object determined as having achromatic color text attribute, to processing for increasing black component in color correction and black generation processing, or processing for removing remaining color component. Thus, there is an effect that black text can be reproduced with high image quality.

According to another embodiment, in the image processing apparatus, the data converting unit subjects an object determined as having text attribute on white background to halftone processing having higher sharpness as compared with an object determined as having other attribute. Thus, there is an effect that text can be reproduced especially on white background with high image quality.

According to one embodiment, in the image processing apparatus, the data converting unit subjects an object determined as having text attribute on color background to the same halftone processing as that performed for a color object on background. Thus, there is an effect that there is no defect caused by switching the processing between the text on a color background and the background portion, and image can be reproduced with high image quality.

According to an image processing system of another embodiment, the system includes the image processing apparatus, and a printer to which a command converted by the data converting unit is input and that carries out printout.

According to a computer program of one embodiment, the computer executes the program to execute: an image attribute determining step of determining image attribute of image data; an object dividing step of dividing the image data into a plurality of objects based on a determination result made at the image attribute determining step; and an object describing step of describing the objects divided at the object dividing step in a predetermined format and converting into a file in a predetermined file format, and at that time, describing an object having a predetermined image attribute among the divided objects such that the object having the predetermined image attribute is linked with an additional object that instructs attribute information. Therefore, the image attribute determined when the image data is formed into the file can be transmitted to the printer driver, and accordingly, the printer driver can perform appropriate image processing in accordance with the image attribute. With this, it is possible to print out an image that satisfies both text image quality and picture image quality, and there is an effect that a file in the object description format can be output from the printer with high image quality.

According to the computer program of yet another embodiment, the computer executes the program to execute a data converting step of converting the file converted at the object describing step into predetermined print instruction suitable for the printer, an object having a predetermined image attribute is determined based on the additional object, and the object is subjected to image processing suitable for the image attribute and the processed object is output from the printer. Therefore, the image attribute determined when the image data is formed into the file can be transmitted to the printer driver, and accordingly, the printer driver can perform appropriate image processing in accordance with the image attribute. With this, it is possible to print out an image that satisfies both text image quality and picture image quality, and there is an effect that a file in the object description format can be output from the printer with high image quality.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
an image attribute determining unit to determine an image attribute of an image data;
an object dividing unit to divide the image data into a plurality of objects based on the image attribute; and
an object describing unit to describe the objects in predetermined formats and convert the objects into a file of a predetermined file format, wherein
the object describing unit describes an object having a predetermined image attribute among the objects by associating an additional object representing information on the predetermined image attribute with the object.

2. The image processing apparatus according to claim 1, further comprising a data converting unit to convert the file of the predetermined file format into a print instruction for a printer and output the print instruction to the printer, wherein
the data converting unit identifies the object having the predetermined image attribute based on the additional object, and performs an image processing to the object based on the predetermined image attribute.

3. The image processing apparatus according to claim 2, wherein when the object is identified as an object having a text attribute, the data converting unit performs a halftone processing with a higher sharpness to the object, compared with an object having another attribute than the text attribute.

4. The image processing apparatus according to claim 2, wherein when the object is identified as an object having a text attribute with an achromatic color, the data converting unit performs an image processing to enhance a black color in color correction and black color generation or an image processing to eliminate any remaining color of the object.

5. The image processing apparatus according to claim 2, wherein when the object is identified as an object having a text attribute with a white background, the data converting unit performs a halftone processing with a higher sharpness to the object, compared with an object having other attribute than the text attribute with the white background.

6. The image processing apparatus according to claim 2, wherein when the object is identified as an object having a text attribute with a color background, the data converting unit performs an identical halftone processing as that for the color background to the object.

7. The image processing apparatus according to claim 1, wherein the additional object is an invisible object.

8. The image processing apparatus according to claim 1, wherein a size of the additional object equals that of the object having the predetermined image attribute.

9. The image processing apparatus according to claim 1, wherein the predetermined file format is a portable document format.

10. An image processing system comprising:
an image processing apparatus including
an image attribute determining unit to determine an image attribute of an image data;
an object dividing unit to divide the image data into a plurality of objects based on the image attribute; and
an object describing unit to describe the objects in predetermined formats and convert the objects into a file of a predetermined file format, wherein the object describing unit describes an object having a predetermined image attribute among the objects by associating an additional object representing information on the predetermined image attribute with the object; and
a printer to receive the print instruction and print the document.

11. An article of manufacture having one or more recordable medium storing instructions which, when executed by a computer, cause the computer to perform a method comprising:
determining an image attribute of an image data;
dividing the image data into a plurality of objects based on the image attribute;
describing the objects in predetermined formats; and
converting the objects into a file of a predetermined file format, wherein describing the objects includes describing an object having a predetermined image attribute among the objects by associating an additional object representing information on the predetermined image attribute with the object.

12. The article of manufacture according to claim 11, wherein the method further comprises:
converting the file of the predetermined file format into a print instruction for a printer;
identifying the object having the predetermined image attribute based on the additional object;
performing an image processing to the object based on the predetermined image attribute; and
outputting the print instruction to the printer.
